(19) United States
(12) Patent Application Publication
(10) Pub. No.: US 2026/0241464 A1
(43) Pub. Date: Aug. 20, 2026

(54) TOOL HOLDER WITH GROOVE RING

(71) Applicant: Albrecht Praezision GmbH & Co. KG, Wernau (DE)

(72) Inventors: Joel Ammersdoerfer, Ebersbach (DE); Martin Schmideder, Leinfelden-Echterdingen (DE)

(21) Appl. No.: 19/540,061

(22) Filed: Feb. 13, 2026

(30) Foreign Application Priority Data
Feb. 19, 2025 (DE) 10 2025 106 200.5

(51) Int. Cl. B23B 31/20; B23B 31/26; F16C 33/58

(52) U.S. Cl. CPC B23B 31/20125; B23B 31/201; B23B 31/261; F16C 33/586

(57) ABSTRACT

Disclosed is a tool holder for clamping a tool using a collet. The tool holder has a base body comprising a machine connection part forming an interface for a spindle mount of a machine spindle. In the base body a holding space is provided in which a clamping rotor is arranged. The clamping rotor is supported between a first axial bearing surface of base body and a second axial bearing surface provided on a bearing ring with view in axial direction parallel to a center axis. The bearing ring is held in the holding space by means of a groove ring inserted into a securing groove. The bearing ring has a ring outer surface for abutment against base body and a ring inner surface for abutment against clamping rotor.

### CROSS REFERENCE TO RELATED APPLICATIONS

This application claims priority under 35 U.S.C. § 119 to the following German Patent Application No. 10 2025 106 200.5, filed on Feb. 19, 2025, the entire contents of which are incorporated herein by reference thereto.

### TECHNICAL FIELD

The present disclosure refers to a tool holder configured to clamp a tool. During operation the tool holder and the tool clamped therein can be preferably rotatingly driven around a center axis of the tool holder, which is in the ideal case also the center axis of the tool. The tool can be a chip-removing tool, such as a milling cutter or a drill.

### BACKGROUND

A tool holder of this type is known from DE 10 2018 111 044 A1, for example. The tool holder has a base body having a machine connection part that forms an interface to a machine spindle mount of a machine spindle. In the base body a holding space is provided. In the holding space a clamping rotor can be used and can be secured by means of a tube-like bearing seat element. The bearing seat element is threaded using an outer thread into an inner thread of the base body. It is arranged in the holding space. A collet can be retracted into the holding space by means of the clamping rotor. By means of the collet the tool to be clamped can be clamped radial relative to the center axis and can be held.

This solution has proven itself in practice and provides high clamping reliability. It also allows high feed rates and high removal rates when using the tool.

It is the object of the present disclosure to further optimize the known tool holder, particularly to re-duce the axial construction length of the tool holder and to improve the positioning accuracy of the tool to be clamped in radial direction radial to the center axis of the tool holder.

This object is solved by means of a tool holder having the features of claim 1.

The tool holder according to the present disclosure is configured for clamping a tool. When a tool is held and clamped the tool holder can be moved, positioned and particularly also rotatingly driven around a spindle axis of a machine spindle by means of the machine spindle of a machine (for example machine tool). Particularly, the tool is a chip removing tool, such as a milling cutter or a drill.

The tool holder has a base body. On the base body a machine connection part is provided that is configured to releasably arrange the tool holder in the machine spindle or a machine spindle mount respectively. The machine connection part can be an interface according to a standard, for example a hollow shank taper (HSK) or a steep shank taper (SK) or another configuration that is particularly standardized. The machine connection part is the interface between the tool holder and the machine spindle mount of the machine, so to speak.

The base body defines a center axis, wherein the machine connection part extends as accurately as possible coaxially relative to the center axis. In doing so, the center axis of the tool holder can be brought into alignment with the spindle axis of the machine spindle if the tool holder is mounted on the machine spindle. The rotation of the machine spindle around the spindle axis thus results in a rotation of the tool holder as well as a tool held therein around the center axis.

As long as nothing else is explicitly indicated in the present description, the direction indications are used as follows: A direction parallel to the center axis is denoted as axial direction. A radial direction is orientated radial to the center axis. A circumferential direction describes the direction onto a circular path around the center axis.

The base body has a holding space. The holding space is accessible from a front facing away from the machine connection part through an access opening. The access opening is arranged on a face of the base body. A first axial bearing surface of the base body adjoins the holding space. The first axial bearing surface is facing the access opening and is arranged with distance to the access opening. The first axial bearing surface can extend in a plane that is orientated orthogonal to the center axis. The first axial bearing surface can have a ring-shaped entirely continuous extension in circumferential direction.

The base body has a securing groove adjacent to the access opening. The securing groove can be configured entirely continuous in circumferential direction. The securing groove can alternatively have a non-continuous, circular arc-shaped extension in circumferential direction. For example, the securing groove is rectangular in its cross-section. The securing groove is open toward the holding space. A groove ring can be inserted into the securing groove via the access opening and the holding space.

Adjacent to the holding space the base body has a circumferential inner surface that is arranged between the securing groove and the first axial support surface with view in axial direction. The circumferential inner surface is particularly a preferably cylindrical surface that is arranged coaxially relative to the center axis, particularly with highest possible accuracy. The circumferential inner surface can directly adjoin the securing groove in axial direction and is preferably arranged with distance to the first axial bearing surface. The circumferential inner surface is preferably a surface, which is planar in axial direction and/or in circumferential direction.

The tool holder has a clamping rotor arranged in the holding space. The clamping rotor can be rotated relative to the base body around the center axis for clamping a tool using an operating device present on the base body, for example a rotating device. Without operation of the operating or rotating device the clamping rotor is thereby held or fixated in its current rotational position relative to the base body, so that an unintentional relative rotation of the clamping rotor relative to the base body is avoided during use of the tool holder in a machine spindle. The coupling between the operating or rotating device and the clamping rotor can thereby be established by means of a gear that comprises a sufficient inhibition against an unintentional release movement of the clamping rotor relative to the base body (for example warm gear or spindle gear).

The clamping rotor has a clamping thread. The clamping thread is configured to cooperate with a collet thread of a collet. The clamping thread is particularly an interior thread. Due to a rotation of the clamping rotor around the center axis relative to the base body (for example using the rotating device) a threaded connection between the clamping thread and the collet thread can be established or released.

The clamping rotor comprises in addition a tube section. The tube section is particularly arranged with distance to the clamping thread in axial direction. The tube section has a tube outer surface facing away from the center axis.

The tool holder comprises additionally a bearing ring that can be releasably arranged on the base body. The bearing ring has a ring inner surface facing the center axis and a ring outer surface facing away from the center axis and the ring inner surface. The ring inner surface and the ring outer surface are preferably arranged coaxially to the center axis and preferably co-axially relative to each other. The ring outer surface and the ring inner surface are surfaces, which are planar in axial direction and/or in circumferential direction in the preferred embodiment.

An accurate coaxial arrangement without deviation cannot be entirely technically realized. Particularly, coaxial arrangements relative to the center axis can have deviations of maximum 10 μm or preferably maximum 7.0 μm or further preferably maximum 5.0 μm and can still allow a sufficiently accurate clamping of a tool.

On the bearing ring, in addition, a second axial bearing surface is provided that faces the first axial bearing surface and is thus facing away from the access opening. The second axial bearing surface extends preferably in a plane orthogonal to the center axis. The second axial bearing surface can be a connection surface between the ring inner surface and the ring outer surface or it can be at least a section thereof. The second axial bearing surface is preferably ring-shaped with an entirely continuous extension in circumferential direction.

The clamping rotor is supported in axial direction indirectly or directly on the first axial bearing surface and the second axial bearing surface and is thus secured in axial direction against an undesired relative movement relative to the base body.

Particularly the bearing ring is threadless. The bearing ring is supported in axial direction on one side indirectly or directly on the clamping rotor and on the other side on the groove ring that is inserted in the securing groove.

By means of the bearing ring and the groove ring a very compact configuration of the tool holder in axial direction can be achieved.

The ring inner surface can provide a two-dimensional contact with the tube outer surface of the tube section of the clamping rotor, while the ring outer surface can provide a two-dimensional contact with the circumferential inner surface of the base body. Thereby the bearing ring can be positioned very precisely in radial direction, which in turn results in that the tube section of the clamping rotor is very precisely arranged in radial direction relative to the center axis. In comparison to a thread-connected bearing element a high positioning accuracy of the clamping rotor and a tool to be clamped can be achieved in radial direction.

During establishment of a threaded connection a relative position between the connected parts in radial direction can be achieved, whereby the relative position highly depends on the accuracy of the thread production. A high accuracy thread production is cumbersome. On the contrary, the bearing ring provides the possibility to provide surfaces that are planar in circumferential direction and in axial direction (ring inner surface and ring outer surface), which together with an assigned surface that is also planar in circumferential direction and in axial direction (particularly circumferential inner surface on base body or tube outer surface on tube section) facilitate a fitting with low play and thus with very high positioning accuracy. Using the tube section a collet inserted or threaded therein can be very precisely orientated and positioned in radial direction. This positioning accuracy does not require high precision manufacturing of the clamping thread and the collet thread.

It is preferred if the circumferential inner surface and the ring outer surface form a first fitting surface pair and the ring inner surface and the tube outer surface form a second fitting surface pair, wherein the fitting surface pairs are respectively configured as fitting having low play or as fitting with zero play. The fitting surfaces of the two fitting surface pairs are threadless and are preferably planar surfaces with view in circumferential direction and in axial direction.

As explained, a rotating device can be provided on the base body, which comprises a tool interface or another suitable operating element accessible from outside, for example. Via the tool interface the rotating device can be operated, so that the rotating device can also be denoted as operating device. The rotating device has a coupling device (for example a gear) coupled with the clamping rotor. The coupling device is particularly configured in self-locking manner. During an actuation of the tool interface the clamping rotor rotates around the center axis relative to the base body. This relative rotation position between the clamping rotor and the base body remains if the tool interface and thus the rotating device is not actuated, that is particularly also if the tool holder and the tool clamped therein is used (for example in a condition ready for operation inserted into a machine spindle).

In a preferred embodiment the tool holder comprises an axial bearing arrangement. The axial bearing arrangement is configured to support the clamping rotor in axial direction on the first axial bearing surface and/or the second axial bearing surface. In a preferred embodiment the axial bearing arrangement comprises a roller bearing that is arranged between the first axial bearing surface and the clamping rotor, so that the clamping rotor can be indirectly supported on the first axial bearing surface via the roller bearing. Alternatively or additionally between the first axial bearing surface and/or the second axial bearing surface on one hand and the clamping rotor on the other hand a support ring of the axial bearing arrangement can be present.

The at least one support ring can directly abut against the clamping rotor. Via the at least one support ring the contact between the clamping rotor to the roller bearing on one hand and to the second axial bearing surface on the other hand can be improved and particularly the contact surface can be enlarged in radial direction.

Adjacent to the holding space a ring support surface can be arranged on the base body. The ring support surface can be arranged around the center axis, for example coaxially around the center axis as accurate as possible, and can be ring-shaped with continuous extension in circumferential direction. The ring support surface is facing the access opening and extends preferably in a plane that is orientated orthogonal to the center axis.

The ring support surface can be arranged adjacent to the circumferential inner surface of the base body. The circumferential inner surface is thereby located between the ring support surface and the securing groove. On the ring support surface the bearing ring can be supported in axial direction.

In a preferred embodiment the ring support surface has an inner diameter that is at least as large as the outer diameter of the first axial bearing surface. Preferably the inner diameter of the securing groove is as large as the outer diameter of the ring support surface.

Preferably the tool holder comprises a front part having a clamping channel. The clamping channel is limited by a conical interior clamping surface of the front part. The interior clamping surface completely surrounds the center axis in circumferential direction. During clamping of the collet in the clamping rotor the interior clamping surface urges the collet at the clamping channel of the front part radially inwardly in order to clamp a tool arranged there and to fixate it in the collet.

For example, the front part can be releasably arranged on the base body using a threaded connection or another suitable connection. When the connection of the front part on the base body is established, the clamping channel is arranged adjacent to the access opening. The front part is particularly not configured to secure or support the clamping rotor, the bearing ring or any other component of the tool holder arranged in the holding space of the base body in axial direction.

The front part can be arranged on the base body, so that the relative position in radial direction between the collet and the tool to be clamped is defined mainly or exclusively by the bearing ring and the clamping rotor and particularly the tube section of the clamping rotor. For example, for this purpose, the front part can be slightly movable in radial direction relative to the base body, for example in that the connection between the front part and the base body provides a respective play in radial direction.

### BRIEF DESCRIPTION OF THE DRAWINGS

Advantageous embodiments of the present disclosure are derived from the dependent claims, the description and the drawing. In the following, preferred embodiments of the present disclosure are explained in detail based on the attached drawing. The drawing shows:

FIG. 1 a side view of an embodiment of a tool holder,

FIG. 2 the tool holder of FIG. 1 in a perspective explosion illustration,

FIG. 3 the tool holder according to FIGS. 1 and 2 in a partly cut side view in explosion illustration,

FIG. 4 the tool holder according to FIGS. 1 to 3 in a longitudinally cut view along the center axis of the tool holder,

FIG. 5 an illustration in part of the front area of the tool holder according to FIGS. 1 to 4 in a longitudinally cut view along the center axis,

FIG. 6 a highly schematic basic illustration for explanation of the configuration and the function of the tool holder according to FIGS. 1 to 5 and

FIGS. 7 and 8 a modified embodiment of a bearing ring for a tool holder according to FIGS. 1 to 6.

### DETAILED DESCRIPTION

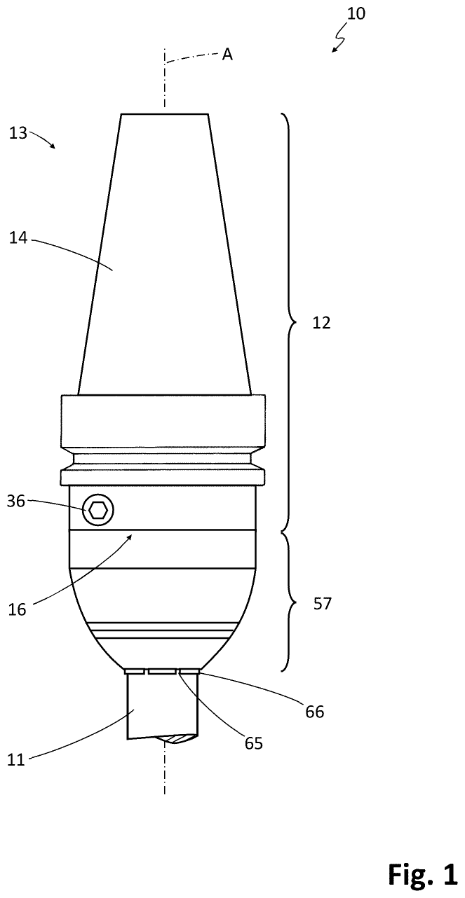

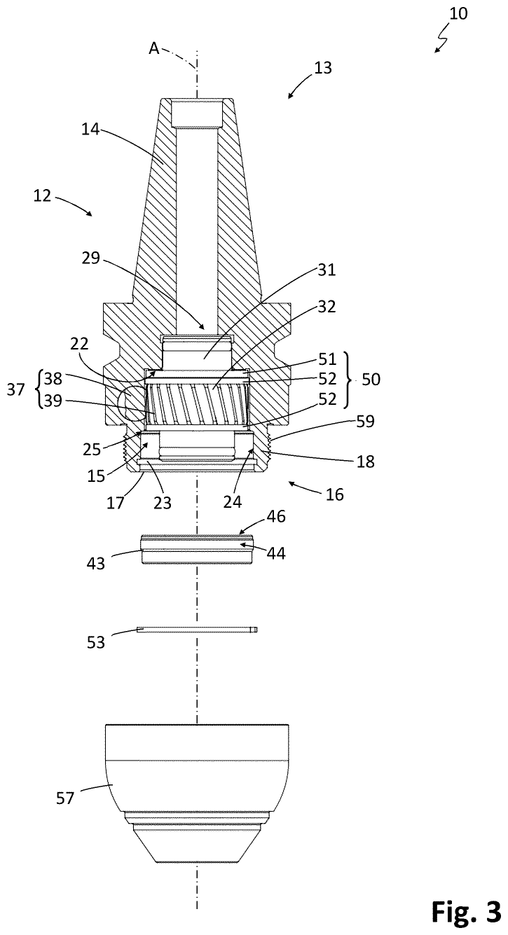

In FIGS. 1 to 4 an embodiment of a tool holder 10 is shown in different illustrations. The tool holder 10 is configured to clamp a tool 11. In a condition ready for operation the tool 11 is clamped in force-fit manner in a radial direction radial to a center axis A.

Also for the following description of the embodiments illustrated in the figures it applies: A direction orientated parallel to the center axis A is denoted as axial direction. A radial direction is orientated radial to the center axis A. A circumferential direction describes the direction on a circular path around the center axis.

The tool holder 10 has a base body 12. On a back 13 base body 12 has a machine connection part 14. The machine connection part 14 provides an interface of tool holder 10 in order to be able to arrange the latter in a spindle mount of a machine spindle and to rotatingly drive it together with the machine spindle. The machine connection part 14 has a shape corresponding to a standardized interface for a machine spindle, for example the shape of a tool taper, which are by way of example illustrated in a form of a steep taper shank (SK). Alternatively, instead of a steep shank taper, also a hollow shank taper or another standardized interface can be used as machine connection part 14.

A holding space 15 is present in the base body 12. The holding space 15 can at least partly comprise a cylindrical and/or conical shape, whereby different diameters can result in a stepped contour of the holding space 15, as it is the case in the present embodiment. The holding space 15 is accessible from outside via an access opening 17 on a front 16 opposite to the back 13 of the base body 12. In the embodiment the access opening 17 is circular and surrounded in circumferential direction around the center axis A by a ring part 18 of base body 12. The ring part 18 is hollow cylindrical and according to the example arranged, coaxial to the center axis A as far as possible.

In axial direction with distance to the access opening 17 base body 12 comprises a first axial bearing surface 22 adjoining the holding space 15. In the embodiment the first axial bearing surface 22 extends in a plane that is orientated orthogonal to the center axis A. The first axial bearing surface 22 is facing the access opening 17. In the embodiment the first axial bearing surface 22 is configured as circular ring surface and is planar with view in radial direction as well as in circumferential direction. A diameter D1 of the access opening 17 is at least as large or larger than an outer diameter D2 of the first axial bearing surface 22.

Adjacent to the access opening 17 base body 12 comprises a securing groove 23. According to the example, securing groove 23 is configured as ring groove and completely surrounds the center axis A in circumferential direction. Preferably, securing groove 23 is coaxially arranged relative to the center axis A as precise as possible. The securing groove 23 is open in radial direction, that means toward the center axis A and thus toward the holding space 15. A groove cross-section of securing groove 23 can be rectangular or square. The securing groove 23 is arranged in ring part 18 of base body 12.

On the base body 12 a circumferential inner surface 24 is provided between the first axial bearing surface 22 and the securing groove 23 and adjoining the holding space 15. The circumferential inner surface 24 is coaxially arranged relative to the center axis A as accurate as possible and can be preferably configured as cylinder surface. According to the example, the circumferential inner surface 24 is a surface, which is planar in axial direction and in circumferential direction. The circumferential inner surface 24 can directly adjoin the securing groove 23 or can be arranged with distance thereto. In the embodiment the circumferential inner surface 24 is arranged on the ring part 18 of base body 12.

Between the circumferential inner surface 24 and the first axial bearing surface 22 ring part 18 comprises a ring support surface 25. The ring support surface 25 is facing access opening 17 and extends in a plane, that is orientated orthogonal to the center axis A, according to the example. The ring support surface 25 can directly adjoin the circumferential inner surface 24. In the embodiment the ring support surface 25 is arranged in ring part 18 of base body, 12.

In the embodiment the diameter of the circumferential inner surface 24 corresponds to the diameter D1 of the access opening 17. An outer diameter of the ring support surface 25 can correspond to the diameter of the circumferential inner surface 24 or can also be smaller. An inner diameter D3 of the ring support surface 25 is smaller than the diameter of the circumferential inner surface 24 and for example also smaller than the diameter D1 of the access opening 17.

The holding space 15 is configured to arrange a clamping rotor 29 in the holding space 15 of base body 12. The clamping rotor 29 has a clamping thread 30. The clamping thread 30 is configured as interior thread and can be arranged in a tube-shaped end part 31 of the clamping rotor 29. A central part 32 of clamping rotor 29 adjoins the tube-shaped end part 31. On the side opposite the end part 31 of central part 32, clamping rotor 29 comprises a tube section 33 having a tube outer surface 34. In the embodiment tube outer surface 34 is a cylinder surface and extends, therefore, in a planar manner in axial direction and in circumferential direction. The tube outer surface 34 is coaxially arranged relative to the center axis A as accurate as possible.

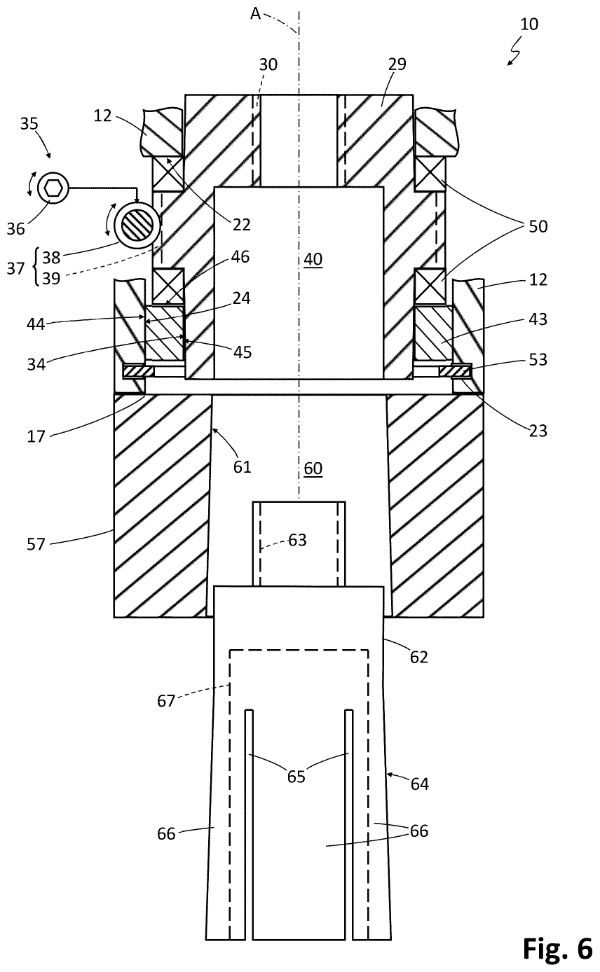

By means of a rotating device 35 (compare particularly FIG. 6) clamping rotor 29 can be rotated relative to base body 12 around center axis A. The rotating device 35 can also be denoted as operating device, by means of which clamping rotor 29 can be operated or rotated relative to base body 12. For this purpose, rotating device 35 has an operating element 36 that is accessible from outside and arranged on base body 12. The operating element 36 can have a standardized interface in order to actuate and for example rotate the operating element 36 by means of a tool. The operating element 36 can therefore comprise a tool interface for a standard tool, such as a wrench, a screwdriver, a hexagon wrench, a hexalobular wrench, etc. For example, operating element 36 can comprise a hexagonal socket, a hexagonal head, a hexalobular socket or another known standardized tool interface.

The rotating device 34 comprises in addition a coupling device 37 and particularly a coupling gear, in order to couple the operating element 36 with clamping rotor 29 and according to the example with central part 33. The coupling device 37 can be or can comprise a worm gear, for example. In the embodiment coupling device 37 comprises a worm shaft 38 that can be rotated around its longitudinal axis by means of the operating element 36, wherein the worm shaft 38 is engaging a worm wheel 39 arranged around center axis A and connected in torque-proof manner with clamping rotor 29. The worm wheel 39 can be an integral or monolithic part of clamping rotor 29. According to the example, the worm shaft 38 extends orthogonal and with distance to center axis A. A basic illustration of the rotating device 35 is schematically depicted in FIG. 6.

Preferably coupling device 37 (according to the example the worm gear) is configured with sufficient inhibition. Therefore, without operation of the operating element 36, a relative rotation of clamping rotor 29 relative to base body 12 is blocked at presence of forces, torques and vibrations occurring during use. Thus, during correct intended use of tool holder 10 the forces acting on the clamping rotor 29 do not result in a relative rotation relative to the base body 12. Such a relative rotation can only be achieved using the rotating device 35 and according to the example operating element 36.

The clamping rotor 29 has a rotor interior 40 completely extending the clamping rotor 29 in axial direction in the embodiment. At least the rotor interior 40 is accessible from the side assigned to the access opening 17 and is limited at least at one position by clamping thread 30.

For axial support of clamping rotor 29 tool holder 10 comprises a bearing ring 43. The bearing ring 43 has a ring outer surface 44 facing away from the center axis A and a ring inner surface 45 facing center axis A. The ring outer surface 44 and the ring inner surface 45 can overlap with view in axial direction and are in an embodiment arranged coaxially relative to each other as accurate as possible and are arranged coaxially relative to the center axis A as accurate as possible. With view in axial direction the extensions of ring outer surface 44 and ring inner surface 45 can be different, wherein the axial extension of ring outer surface 44 can be smaller than the axial extension of ring inner surface 45. The ring outer surface 44 and the ring inner surface 45 are planar with view in axial direction and in circumferential direction.

The outer diameter of ring outer surface 44 and the diameter of the circumferential inner surface 24 are defined, so that the ring outer surface 44 and the circumferential inner surface 24 form a first fitting surface pair. The diameter of ring inner surface 45 and the diameter of tube outer surface 34 are defined, so that ring inner surface 45 and tube outer surface 34 form a second fitting surface pair.

The bearing ring 43 can be press fitted into base body 12. The fitting surface pair consisting of ring outer surface 44 and circumferential inner surface 24 therefore forms a press fitting that is free of play. In addition, also the second fitting surface pair consisting of ring inner surface 45 and tube outer surface 34 can provide a fitting that is free of play.

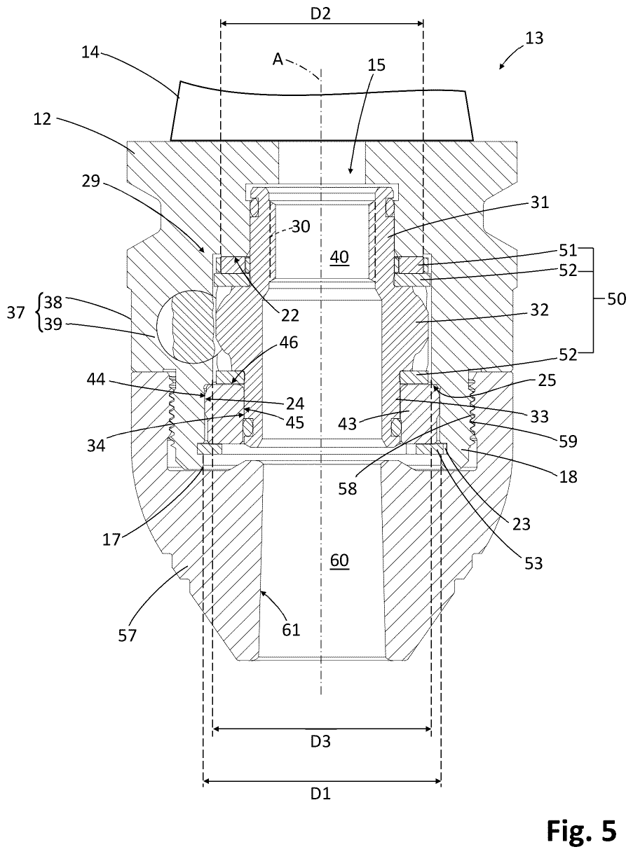

As particularly apparent from the detailed illustration in FIG. 5, the bearing ring 43 is arranged between the ring part 18 of base body 12 and the tube section 33 of clamping rotor 29 according to the example. The ring outer surface 44 of bearing ring 43 is in two-dimensional contact with the circumferential inner surface 24 and the ring inner surface 45 is in two-dimensional contact with tube outer surface 34. Due to the two fitting surface pairs 44, 24 or 45, 34 a very precise arrangement of tube section 33 and thus the clamping rotor 29 is achieved in radial direction relative to center axis A.

The bearing ring 43 is threadless and is arranged in the holding space 15 of base body 12 without threaded connection.

On the bearing ring 43 a second axial bearing surface 46 is provided. The second axial bearing surface 46 is facing first axial bearing surface 22. In the embodiment second axial bearing surface 46 extends in a plane that is orientated orthogonal to center axis A. The second axial bearing surface 46 can be defined by a face or a face section of bearing ring 43, that connects ring outer surface 44 with ring inner surface 45.

In axial direction clamping rotor 29 is held between first axial bearing surface 22 of base body 12 and second axial bearing surface 46 of bearing ring 43 and is secured against an undesired movement in axial direction. For this purpose, clamping rotor 29 can be indirectly or directly supported on the axial bearing surfaces 22, 46.

In the illustrated embodiment tool holder 10 comprises an axial bearing arrangement 50 for support of clamping rotor 29. In the embodiment axial bearing arrangement 50 comprises a roller bearing 51 that can be realized as cylinder roller bearing or needle roller bearing, for example. According to the example, roller bearing 51 is directly supported on first axial bearing surface 22. The clamping rotor 29 and according to the example the central part 32 is supported on the roller bearing 51 by means of a support ring 52. In the embodiment the roller bearing 51 and the support ring 52 surround end part 31 of clamping rotor 29 in circumferential direction around center axis A.

The axial bearing arrangement 50 can in addition comprise another support ring 52 by means of which clamping rotor 29 and according to the example central part 32 is supported on the second axial bearing surface 46 of bearing ring 43.

Due to the at least one optional support ring 52, the contact surface and the introduction of force between central part 32 of clamping rotor 29 and the roller bearing 51 and/or the concerned axial bearing surface 22 or 46 can be improved.

In axial direction toward the access opening 17 bearing ring 43 is held or secured by means of a groove ring 53 in the embodiment. The groove ring 53 can be a snap ring, for example. In the embodiment groove ring 53 has a rectangular ring cross-section and extends in circumferential direction around center axis A in a circular arc-shaped manner. Two ring ends 54 of groove ring 53 are arranged with distance to each other, so that groove ring 53 comprises an interruption between the ring ends 54.

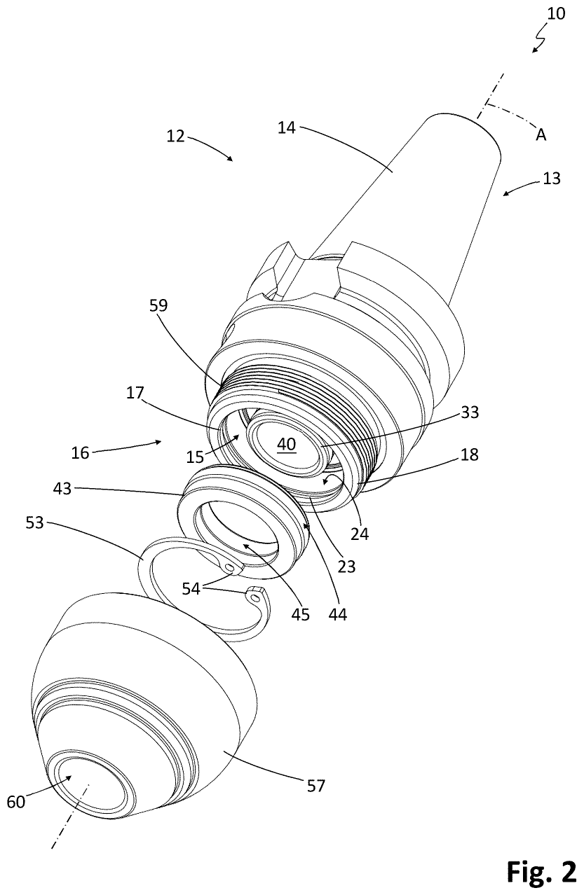

The groove ring 53 is elastically deformable, so that its ring ends 54 can be moved toward each other starting from an initial position (FIG. 2) in order to change the diameter of groove ring 53 due to the elastic deformation. Thereby, the outer diameter of groove ring 53 can be reduced by elastic deformation in order to move it through the access opening 17 into holding space 15 and to insert it there in securing groove 23.

In the assembled condition the ring ends 54 are arranged inside securing groove 23 with distance to one another. The groove ring 53 is elastically deformed in the assembled condition and is in this manner urged or pressed against the groove bottom of securing groove 23. The pressing force between the groove ring 53 and the base body 12 inside securing groove 23 can be so high that in case of forces occurring during correct intended use of the tool holder 10 a relative rotation of the groove ring 53 around the center axis A relative to the base body 12 is impeded.

In the illustrated embodiment bearing ring 43 is supported in axial direction on the side opposite of groove ring 53 on the ring support surface 25 of base body 12. In doing so, the bearing ring 43 can be supported immovably or without play between the ring support surface 25 and groove ring 53 in axial direction without transmitting an excessive axial force onto the axial bearing arrangement 50 or the clamping rotor 29.

The described arrangement allows to configure base body 12 in axial direction in a compact or short manner. A threaded connection for securing clamping rotor 29 inside holding space 15 can be omitted. Due to the fitting surface pairs formed with bearing ring 43, a very precise positioning of clamping rotor 29 in radial direction relative to base body 12 and thus relative to center axis A, defined by base body 12, is made possible.

In the illustrated embodiment tool holder 10 comprises a front part 57. The front part 57 is configured to be releasably attached in a first assembly step on base body 12 and according to the example on ring part 18. For this purpose, front part 57 can comprise an inner thread 58, for example, that can establish a threaded connection with an outer thread 59 of base body 12 and particularly of ring part 18. Alternatively to the threaded connection also other form-fit and/or force-fit connection devices can be used. Additionally or alternatively, for establishment of the releasable connection, front part 57 can be attached to the base body 12 and according to the example to the ring part 18 using a substance joint or an adhesive joint. Particularly, the threaded connection can be additionally adhesively connected.

With established connection of front part 57 with base body 12 the ring part 18 extends into front part 57. According to the example front part 57 does not provide a holding or securing function in order to support or secure a component (for example clamping rotor 29 or bearing ring 43) arranged in the holding space 15 of base body 12 in axial direction. The front part 57 serves particularly exclusively for creation of a clamping force for clamping the tool 11 (as it is explained in further detail in the following).

In axial direction a clamping channel 60 extends completely through front part 57. The clamping channel 60 is at least in sections limited by an interior clamping surface 61. The interior clamping surface 61 is conical. Its diameter increases starting from an end of the clamping channel 60 assigned to the base body 12 toward an opposite front end of clamping channel 60. The clamping channel 60 thus expands conically toward the front away from base body 12. The clamping channel 60 is open toward the holding space 15.

The clamping channel 60 and the rotor interior 40 are aligned relative to each other when the connection between the front part 57 and the base body 12 is established. The clamping channel 60 can be machined after arrangement of the front part 57 on the base body 12 by means of grinding or another high-precision method, so that the clamping channel 60 is coaxially orientated relative to center axis A as accurately as possible.

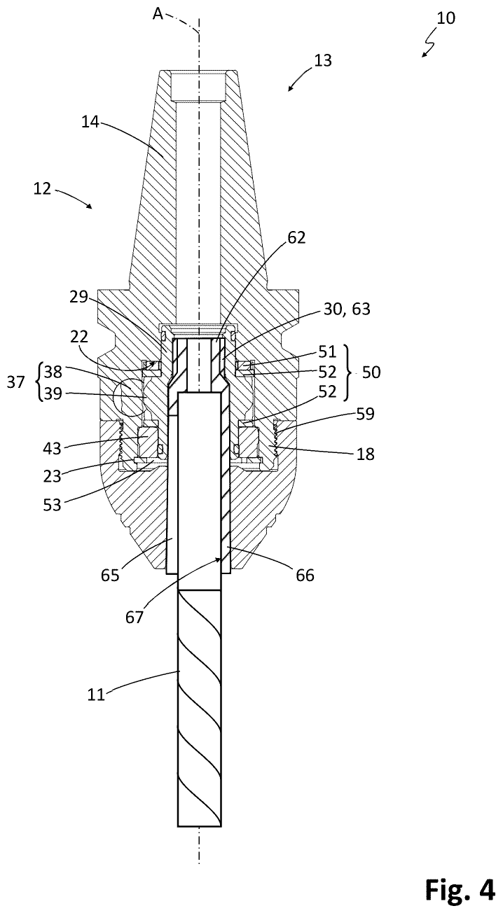

For clamping the tool 12 in the tool holder 10 the tool holder 10 comprises a collet 62. The collet 62 is schematically illustrated in FIGS. 4 and 6. The collet 62 has a collet thread 63 configured to establish a threaded connection with clamping thread 31 of clamping rotor 29. The collet thread 63 can be arranged on a cylindrical or tube-shaped end of collet 62.

Adjoining the end opposite the collet thread 63 the collet 62 comprises a conical collet outer surface 64. The collet outer surface 64 is configured to cooperate with interior clamping surface 61 in order to deform the collet at least in an axial section radially inwardly. For this purpose, collet 62 has one and preferably multiple slits 65 extending in axial direction. The slits 65 are arranged in a region of the conical collet outer surface 64 in order to separate finger-like clamping elements 66 from each other with view in circumferential direction around center axis A. The slits 65 extend starting from a front end of the collet 62 into the collet 62, pass through the collet 62 in axial direction, however not entirely. In the interior the collet 62 comprises a collet interior 67 that is accessible from outside on the side opposite the collet thread 63 so that a tool 11 or a tool shank of the tool 11 can be inserted in the collet interior 67 in order to be arranged there inside of clamping element 66 (FIG. 4).

For clamping a tool by means of any embodiment of the tool holder 10 the procedure is as follows:
A tool shank of a tool 11 is inserted into the collet interior 67. The collet 62 is inserted through clamping channel 60 into the rotor interior 40 of clamping rotor 29 so that the collet thread 63 and the clamping thread 31 abut in axial direction against one another ready for threading. By means of the rotating device 35 a relative rotation of clamping rotor 29 relative to base body 12 can be carried out, whereby the collet 62 is further pulled into the clamping channel 60 and the rotor interior 40. Thereby the interior clamping surface 61 applies a radial force on collet outer surface 64, thereby urging the clamping element 66 radially inwardly. This movement is made possible due to the play provided by the slits 65. In doing so, the portion of the tool 11 arranged in the clamping interior 67 (for example tool shank) is applied with a clamping force and is clamped in the collet 62. The collet 62 in turn is held in the tool holder 10 due to the threaded connection between the collet thread 63 and the clamping thread 61.

Because the rotating device 35 provides a self-locking effect, an unintentional release of the tool from the tool holder 10 is avoided when using the tool 11 (for example during machining of a workpiece). The tool 11 can be rotatingly driven around center axis A by means of tool holder 10 via the machine spindle of a machine, for example in order to machine a workpiece in a chip-removing manner. The tool 11 can be a milling cutter or a drill, for example.

Releasing a tool 11 can again be carried out by actuating the rotating device 35 in order to release the threaded connection between clamping thread 31 and collet thread 63 and to remove collet 62 from base body 12.

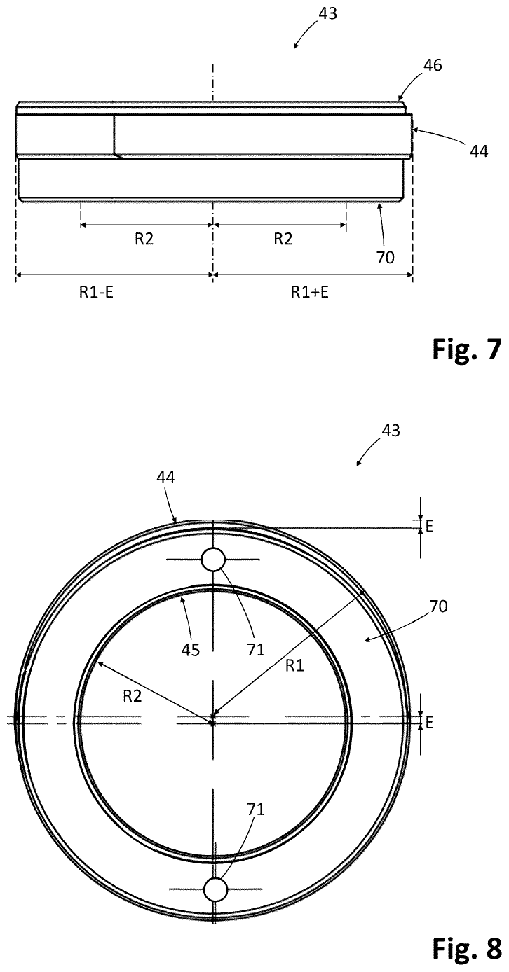

In FIGS. 7 and 8 a modified embodiment of bearing ring 43 is illustrated. In this bearing ring 43, ring outer surface 44 and ring inner surface 45 are not as far as possible concentrically relative to each other, but rather offset relative to each other by eccentricity E.

The ring outer surface 44 has a radius R1, while ring inner surface 45 has a radius R2. In a face 70 modified compared to second axial bearing surface 46, bearing ring 43 can have multiple and for example two holes 71 that are particularly arranged diametrically opposed at a position of maximum eccentricity E. The holes 71 can serve for inserting a tool and for rotating bearing ring 43 relative to base body 12. Instead of the holes 71 on the face 70 also other elements could be provided on which a tool may act for rotating the bearing ring 43 relative to base body 12.

Because of the eccentric arrangement of ring outer surface 44 relative to ring inner surface 45, the possibility is provided to position the ring inner surface 45 coaxially around the center axis A of base body 12 as accurately as possible, if the circumferential inner surface 24 is arranged outside a predefined tolerance around center axis A. Different to the embodiments described above, thus an intended eccentricity E between ring outer surface 44 and ring inner surface 45 is provided on bearing ring 43, so that the position of the ring inner surface 45 compared with center axis A defined by base body 12 can be adjusted after arrangement of bearing ring 43 in holding space 15. Apart from the eccentricity E of bearing ring 43, the tool holder 10 can be configured and used similar to any of the above-described embodiments.

The present disclosure refers to a tool holder 10 for clamping a tool 11 using a collet 62. The tool holder 10 has a base body 12 comprising a machine connection part 14 forming an interface for a spindle mount of a machine spindle. In the base body 12 a holding space 15 is provided in which a clamping rotor 29 is arranged. The clamping rotor 29 is supported between a first axial bearing surface 22 of base body 12 and a second axial bearing surface 46 provided on a bearing ring 43 with view in axial direction parallel to a center axis A. The bearing ring 43 is held in the holding space 15 by means of a groove ring 53 inserted into a securing groove 23. The bearing ring 43 has a ring outer surface 44 for abutment against base body 12 and a ring inner surface 45 for abutment against clamping rotor 29. By means of bearing ring 43 clamping rotor 29 can be very precisely positioned relative to base body 12 in radial direction and thus very precisely around the center axis A of base body 12 (small deviation from ideal coaxial arrangement). The bearing ring 43 is particularly threadless and also secured in threadless manner on base body 12.

### LIST OF REFERENCE SIGNS

10 tool holder
11 tool
12 base body
13 back of base body
14 machine connection part
15 holding space
16 front of base body
17 access opening
18 ring part
22 first axial bearing surface
23 securing groove
24 circumferential inner surface
25 ring support surface
29 clamping rotor
30 clamping thread
31 end part of clamping body
32 central part of clamping body
33 tube section
34 tube outer surface
35 rotating device
36 operating element
37 coupling device
38 worm shaft
39 worm wheel
40 rotor interior
43 bearing ring
44 ring outer surface
45 ring inner surface
46 second axial bearing surface
50 axial bearing arrangement
51 roller bearing
52 support ring
53 groove ring
54 ring ends
57 front part
58 inner thread
59 outer thread
60 clamping channel
61 interior clamping surface
62 collet
63 collet thread
64 collet outer surface
65 slit
66 clamping element
67 collet interior
70 face of support ring
71 hole
A center axis
D1 diameter of access opening
D2 outer diameter of first axial bearing surface
D3 inner diameter of ring support surface
E eccentricity
R1 radius of ring outer surface
R2 radius of ring inner surface

1. A tool holder for clamping a tool, wherein the tool holder comprises:
a base body extending along a center axis (A) comprising:
a machine connection part configured for arrangement of the tool holder in a mount of a machine spindle,
a holding space comprising an access opening on a front facing away from the machine connection part,
a first axial bearing surface that is arranged adjacent to the holding space and with distance to the access opening,
a securing groove that is arranged between the access opening and the first axial bearing surface and
a circumferential inner surface that is arranged between the securing groove and the first axial bearing surface,
a clamping rotor arranged in the holding space, the clamping rotor having a clamping thread, which is configured to establish a threaded connection with a collet thread, and having a tube section extending around the center axis (A),
a bearing ring that is arranged on the base body and that comprises a ring outer surface for abutment against the circumferential inner surface, a ring inner surface for abutment against a tube outer surface of the tube section and a second axial bearing surface that faces the first axial bearing surface, wherein the clamping rotor (29) is directly or indirectly supported on the first axial bearing surface and the second axial bearing surface, a groove ring inserted into the securing groove and supported on bearing ring.

2. The tool holder according to claim 1, wherein the circumferential inner surface and the ring outer surface form a first fitting surface pair and wherein the ring inner surface and the tube outer surface form a second fitting surface pair.

3. The tool holder according to claim 1, wherein the bearing ring is configured without thread.

4. The tool holder according to claim 1, further comprising a rotating device arranged on the base body and coupled with the clamping rotor in order to rotate the clamping rotor around the center axis (A) relative to the base body.

5. The tool holder according to claim 1, further comprising an axial bearing arrangement that is configured to axially support the clamping rotor on the first axial bearing surface and/or the second axial bearing surface.

6. The tool holder according to claim 5, wherein the axial bearing arrangement comprises a roller bearing that is arranged between the first axial bearing surface and the clamping rotor.

7. The tool holder according to claim 5, wherein the axial bearing arrangement comprises a support ring that is arranged between the clamping rotor and the first axial bearing surface.

8. The tool holder according to claim 3, wherein the axial bearing arrangement comprises another support ring that is arranged between the clamping rotor and the second axial bearing surface.

9. The tool holder according to claim 1, wherein the base body comprises a ring support surface adjacent to the holding space, wherein the ring support surface faces the access opening and supports the bearing ring.

10. The tool holder according to claim 9, wherein an inner diameter of the ring support surface is at least as large as an outer diameter of the first axial bearing surface.

11. The tool holder according to claim 1, further comprising a front part that comprises a clamping channel limited by a conical interior clamping surface.

12. The tool holder according to claim 11, wherein the front part and the base body are configured to be releasably connected with each other, particularly by means of a threaded connection.

13. The tool holder according to claim 11, wherein the clamping channel is arranged adjacent to the access opening.

14. The tool holder according to claim 1, wherein, when the threaded connection between clamping thread and collet thread of the collet is established, a collet outer surface is urged against the interior clamping surface of front part.
